(19) United States
(12) Patent Application Publication
(10) Pub. No.: US 2011/0010971 A1
(43) Pub. Date: Jan. 20, 2011

(54) Identification Animal Tags and Related Methods of Use

(76) Inventors: Laura Erickson, Venice, CA (US); Kimberly G. Capria, Venice, CA (US)

Correspondence Address: John Karl Buche;BUCHE & ASSOCIATES, P.C., 875 PROSPECT, SUITE 305, LA JOLLA, CA, 92037, US

(21) Appl. No.: 12/571,297

(22) Filed: Sep. 30, 2009

Related U.S. Application Data
(60) Provisional application No. 61/225,438, filed on Jul. 14, 2009.

(51) Int. Cl. G09F 3/00

(52) U.S. Cl. 40/300

(57) ABSTRACT

Disclosed is an animal tag and related methods of use.

### CROSS-REFERENCE TO RELATED APPLICATIONS

This application claims the benefit of U.S. Provisional Patent Application Ser. No. 61/225,438 (filed on Jul. 14, 2009) entitled, “BARKCODE™ is a collection of Photo ID Pet Tags that have a picture of the pet along with a unique URL for that specific pet and/or a unique specific barcode that will contain important data on that specific pet.”

### STATEMENT REGARDING FEDERALLY SPONSORED RESEARCH OR DEVELOPMENT

N/A

### BACKGROUND OF THE INVENTION

1. Field of Invention

The present invention is in the field of animal identification tags.

2. Background of the Invention

For years, animal owners have struggled to find lost animals or stolen animals. Over time, the use of animal identification tags has been the primary method for animal owners to have lost or stolen animals returned to their custody. However, identification tags and licensing tags do not provide enough information for the lost or stolen animal to efficiently and quickly be returned to the animal owners.

To address this problem, various identification tags have been created to solve the information deficiencies of ordinary identification or licensing tags. U.S. Pat. No. 7,578,433 (issued Aug. 25, 2009), for example, discloses the placement of one-dimensional bar-codes on the identification tag whereby information necessary for returning the animal with its owner may be read by a personal digital assistant and communicated to the animal finder. However, such a tag does not fully resolve the information deficiency since: (1) the animal cannot be identified as the subject of the animal tag; and, (2) obtaining necessary information for returning the animal to its owner depends on the animal finder possessing a personal digital assistant capable of reading one-dimensional bar codes at the time of the find and, therefore, reading the information cannot otherwise be accomplished on-the-spot. Moreover, the cited reference does not allow the finder to communicate information to the owner via social network communication.

In addition, many animals are admirable to non-owners. The cited reference does not permit admirers of the animal to view the identification tag and thereby participate in an online social network with the animal owner and the animal.

### SUMMARY OF THE INVENTION

Accordingly, it is an object of the present invention to provide an apparatus capable of providing on-the-spot animal identification and a system for facilitating the on-the-spot identification and of an animal.

It is a further object of the present invention to provide a method of participating in a social network via the use of animal identification tags.

### BRIEF DESCRIPTION OF THE FIGURES

The manner in which these objectives and other desirable characteristics can be obtained is explained in the following description and attached figures in which:

FIG. 1 depicts a first side of an animal identification tag 100.

FIG. 2 depicts a preferable embodiment of a second side of the animal identification tag 100 depicted in FIG. 1.

FIG. 3 depicts another preferable embodiment of a second side of the animal identification tag 100 depicted in FIG. 1.

FIG. 4 depicts another preferable layout of a second side of the animal identification tag 100 depicted in FIG. 2.

It is to be noted, however, that the appended figures illustrate only typical embodiments of this invention, and therefore, are not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

The present invention is an animal identification tag to be used in a method for recovering lost or stolen animals or a method for operating/participating in a social network. In general, the animal identification tag may feature at least a first and a second side. On the first side, the identification tag suitably may feature, among other things, an identifying photograph or image of a subject animal and additional information regarding the subject animal. On the second side, the identification tag may suitably feature, among other things, a bar code, a URL, or other means for communicating information. The barcode may be read and information interrogated by a bar code scanner, PDA, mobile phone or cellular device on-the-spot.

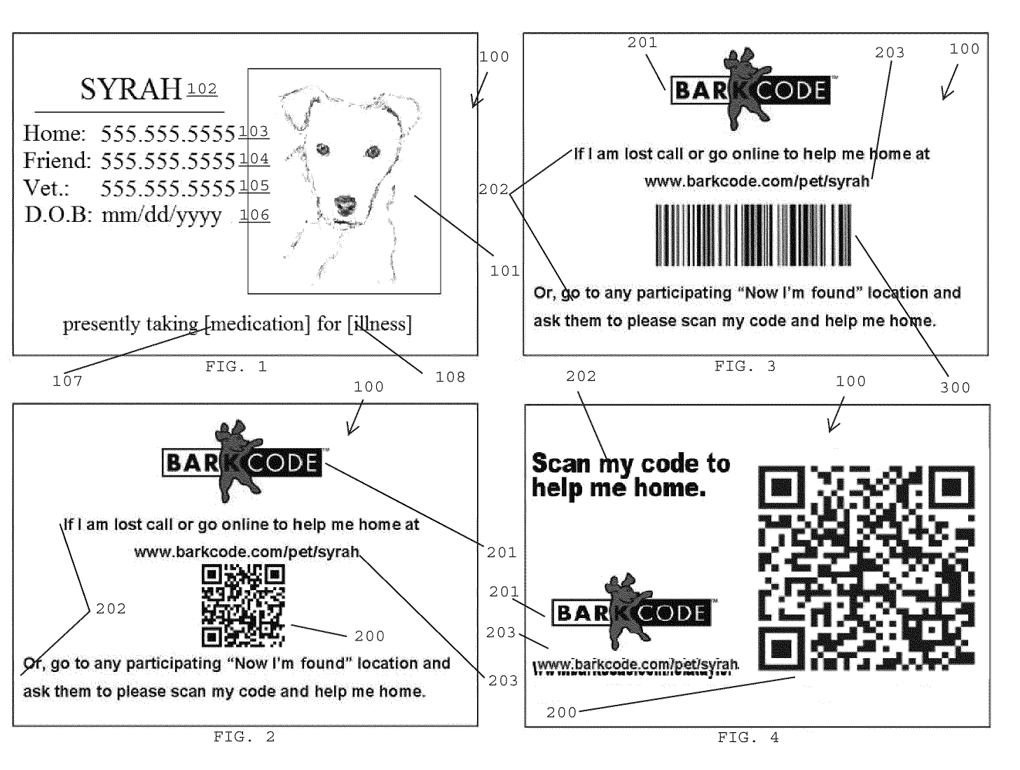

FIG. 1 depicts a first side of one non-limiting embodiment of an animal identification tag 100. This side of the identification tag 100 is primarily for identifying that the animal wearing the tag 100 is the subject of the tag 100 and for conveying preliminary information regarding the subject animal. The first side may comprise any of the following fields of information, which include but are not limited to the following types of information: a picture of the animal 101; the animal's name 102 or license number; description of the animal, fur color, eye color, identifying marks, the owner's telephone number 103; a friend's telephone number 104; a veterinarian's phone number 105; the animal's date of birth 106; any medications the animal may need 107; or any medical condition the animal may have 108.

Still referring to FIG. 1, the first side of the identification tag 100 may feature any ornamental design or any layout. FIG. 1 depicts a suitable plain white plus standard text ornamental design for the first side of the identification tag 100. Other ornamental designs may be used, including the appearance of a drivers' license, credit card, Medicare card (spoofed as Pet-a-care), or any other spoof or imitation of a human identification card. FIG. 1 also depicts a suitable layout of the first side of the identification tag 100 consisting of: a photograph 101 of the subject animal on one side; animal name 102 plus information 103, 104, 105, 106; and, medical information 107, 108 along the bottom. Any other layout of the first side of the identification tag 100 is also suitable.

FIG. 2 depicts a non-limiting embodiment of a second side of the animal identification tag 100. This embodiment of the animal identification tag 100 is primarily for communicating to the animal finder the preferable manner for reuniting the animal with its owner. The second side of the identification tag 100 may comprise any of the following: an advertising region 201; a message region 202; a URL 203 (for example www.barkcode.com/pet/syrah or www.barkcode.com/syrah are URLs that may be used); or a coded means to convey information, such as a barcode 200. The barcode 200 of FIG. 2 is preferably a two-dimensional matrix code, although other identifying means, including RFID, may be used. Specifically, depicted is a Quick Response (“QR”) code, however, any type or embodiment of a two-dimensional matrix code is also suitable (e.g., Semacode, ECC200 code or ECC200, Micro QR Code). In addition, the second side of the identification tag 100 may feature any design or layout for its contents. In FIG. 4, for example, the layout is different than FIG. 2 where the barcode 200 (QR code) may be moved to a side and enlarged; the advertising region 201 is moved to another side; the URL 203 is moved down and to a side; and, a message region 202 is moved up and to a side. Fields of information may be conveyed in a variety of ornamental layouts for purposes of accomplishing the ends of this application.

FIG. 3 depicts an alternate embodiment of the second side of the identification tag 100. FIG. 3 is similar to FIG. 2 except the barcode is a linear barcode 300.

It should be noted that the contents of the first or second side of the tag 100 could alternate and it is not critical exactly which side features the specific fields of information.

The present application further discloses a systems and methods for recovering lost or stolen animals. In general, the method comprises the following steps: obtaining an identification tag 100 of the present application adapted to be placed on an animal that contains fields for information; logging into an online profile and entering information for reuniting the animal and its owner as preparation for whenever the animal is lost or stolen; maintaining the profile in a database; assigning the profile and profile location within the database to the identifying means, such as a barcode 200, 300, RFID tag, or URL 203 on the identification tag 100. All other fields of data may also be assigned to the tag, which is placed on one's animal. In the event an animal is lost or misplaced, any person with a proper interrogating device as described above can discover information about the animal and owner by interrogating the identification tag 100. A finding party can visually identify that the animal wearing the identification tag 100 is the subject of the identification tag 100 in instances where the tag 100 contains a photograph. A variety of mechanisms may be used to interrogate the device. One may accomplish revealing information fields by reading the information fields, for instance by bar code 200, 300 on the identification tag 100, using a cellular phone (some having camera capabilities). Using such a device, scanner, or other similar means, one can obtain the associated information for reuniting the animal with its owner. As an alternative to reading a bar code 200, 300, a URL 203 on the second side of the identification tag 100, or RFID tag, could be used to obtain the information for reuniting the animal with its owner.

The type of information communicated to the online profile and database will preferably vary from animal owner to animal owner depending on the specific owner's preferences for reuniting the owner with a lost or stolen animal. Typical information that may be included in the profile, includes but would not be limited to, the following: location of the owner; names and location of a veterinarian clinics or stores that have volunteered to accepted found lost or stolen animals as an intermediary between the finder and the owner; other protocols for reuniting a lost or stolen animal with the owner; and other pertinent information about the animal, the animals condition, the animal's behavioral tendencies, breeding information, stud fees, lineage, pedigree, and feeding; and the like.

The present application further discloses a new method for operating or participating in a social network that mergers information about animals and owners. In general, this application discloses an embodiment where an identification tag 100 is harnessed and used in conjunction with online social networking websites. One such method comprises the following steps: obtaining an identification tag 100 for an animal adapted to receive fields of information, for instance via a barcode 200, 300, RFID tag, or URL 203 mechanism; assigning a barcode 200, 300 or URL 203 (or other identifying device) to an online profile within an online community; entering information (including photographs, behavioral characteristics, likes, personality, and other desired fields of information) regarding the subject animal of the identification tag 100 into the online profile; allowing others to access and view the online profile via visiting the URL 203 directly or via reading/interrogating the fields of information barcode 200, 300 on said tag 100 with a suitable device. For instance, one such device is a cellular phone, which can read and communicate the profile information to said phone. Information harnessed from the tag 100 can the allow members of the online community to interact with one another; and allow information to be supplied to community members regarding new animal toys, foods, animal nutrition, animal park locations, and the like.

Other methods may be practiced depending on the use of alternative embodiments described herein, and will be readily apparent to those skilled in the art.

I claim:

1. An animal identification tag comprising:
fields of information on said tag about an animal that will wear the tag; and,
a means on said tag for communicating said fields of information.

2. The animal identification tag of claim 1 wherein said means for communicating fields of information is selected from any of the group consisting essentially of at least one URL, at least one one-dimensional bar code, or at least one two dimensional barcode.

3. The animal identification tag of claim 2 wherein said fields of information are for reuniting the subject animal with its owner.

4. The animal identification tag of claim 2 wherein said means for communicating information is at least one QR code.

5. The animal identification tag of claim 2 further comprising a field of information that is an advertising region.

6. The animal identification tag of claim 2 further comprising a field of information that is a message region.

7. The animal identification tag of claim 2 further comprising a field of information that is a photograph of the animal wearing the tag.

8. The animal identification tag of claim 2 further comprising a region for information selected from the group consisting essentially of any of the following types of information: the subject animals name, the subject animal owner's phone number, a friend's phone number, a veterinarian's phone number, the subject animal's date of birth, the subject animal's medical conditions, and the subject animal's medications.

9. A method for reuniting a lost or stolen animal with its owner comprising the steps of:
obtaining an animal identification tag featuring fields of information about the animal, including a photograph, and a means for communicating said fields of information;
placing the tag on the subject animal;
upon losing or misplacing the animal, a person locating said tag on the lost or stolen animal;
identifying via the photograph that the lost or stolen animal is the subject animal;
interrogating said means for communicating information and obtaining the information; and,
using the information to reunite the subject animal with the owner.

10. The method of claim 9 wherein said means for communicating information is selected from any of the group consisting essentially of at least one URL, at least one one-dimensional bar code, RFID tag, or at least one two dimensional barcode.

11. The method of claim 9 further comprising a step after interrogating said means for communicating information involves electronically contacting the owner of said animal via any of the means of the internet, email, or through a social networking website.

12. The method of claim 9 wherein said means for communicating information is at least one QR code.

13. The method of claim 9 wherein the animal identification tag further comprises an advertising region.

14. The method of claim 9 wherein the animal identification tag further comprises a message region.

15. The method of claim 9 wherein the animal identification tag further comprises a region for information selected from the group consisting essentially of the subject animal's name, the subject animal owner's phone number, a friend's phone number, a veterinarian's phone number, the subject animal's date of birth, the subject animal's medical conditions, and the subject animal's medications.

16. A method for participating in a social network using an animal identification tag comprising the steps of:
obtaining an animal identification tag featuring a subject animal and a means for communicating fields of information thereon said tag;
creating an online profile for an animal and an owner;
applying the identification tag to the animal;
linking the online profile to the means for communicating information; and,
allowing others to view the profile after interrogating the means for communicating information on the animal, whereby animals and their owners who have interest in one another can identify and communicate with one another.

17. The method of claim 16 wherein said means for communicating information is selected from the group consisting essentially of at least one URL, at least one one-dimensional bar code, or at least one two dimensional barcode.

18. The method of claim 16 wherein said means for communicating information is at least one QR code.

19. The method of claim 16 wherein the animal identification tag further comprises an advertising region.

20. The method of claim 16 wherein the animal identification tag further comprises a message region.

21. The method of claim 16 wherein the animal identification tag further comprises a region for information selected from the group consisting essentially of the subject animals name, the subject animal owner's phone number, a friend's phone number, a veterinarian's phone number, the subject animal's date of birth, the subject animal's medical conditions, and the subject animal's medications.
